(19) United States
(12) Patent Application Publication
(10) Pub. No.: US 2013/0293783 A1
(43) Pub. Date: Nov. 7, 2013

(54) MOTION VECTOR BASED COMPARISON OF MOVING OBJECTS

(71) Applicants: Caifeng Shan, Eindhoven (NL); Adrianus Marinus Gerardus Peeters, Eindhoven (NL)

(72) Inventors: Caifeng Shan, Eindhoven (NL); Adrianus Marinus Gerardus Peeters, Eindhoven (NL)

(73) Assignee: KONINKLIJKE PHILIPS N.V., EINDHOVEN (NL)

(21) Appl. No.: 13/976,483

(22) PCT Filed: Jan. 16, 2012
(86) PCT No.: PCT/IB2012/050196

§ 371 Date: Jun. 27, 2013

(30) Foreign Application Priority Data
Jan. 28, 2011 (EP) 11152548.1

(51) Int. Cl. H04N 5/262; H04N 5/14

(52) U.S. Cl. CPC H04N 5/2625; H04N 5/145
USPC 348/598

(57) ABSTRACT

The present invention proposes to analyze movements of objects in video sequences (e.g. sport videos), by performing motion estimation to determine motion vectors at each frame. With the calculated motion vectors, the movements of the object(s) (e.g. athlete(s)) can be quantitatively measured. Based on this, movements in two videos can be compared at each individual frame of the video sequence. Different approaches (e.g., color coding) can be used to visualize and compare the movements. With motion estimation, intermediate frames can also be inserted to enable better movement comparison in two given videos.

### FIELD OF THE INVENTION

The invention relates to an apparatus and method and system for comparing movements in video sequences.

### BACKGROUND OF THE INVENTION

Various enhancement techniques have been exploited for sports video broadcasting. The enhancement can give the audience better view experience. For instance, in a car race, the video can be enhanced with graphics which identify the driver of a car and display information such as the speed of the car (e.g. obtained by global positioning system (GPS)). A first example is a video sequence of a football match, where an offside line can be virtually inserted, which enables the viewers to see exactly when and how the foul was committed. Another example is a video sequence for golf, where yardage points, danger zones, sloping fairways and false fronts can be identified and added to the video.

U.S. Pat. No. 7,042,493 and WO 01/78050 A2 disclose motion analyzing systems for generating stroboscope sequences of a sport event from video. Such systems allow viewers to see an athletic movement unfold in time and space, where a moving object is perceived as a series of static images along the object's trajectory.

Furthermore, EP1247255 and WO 01/39130 A1 disclose image processing systems which, given two video sequences, can generate a composite video sequence including visual elements from each of the given sequences, suitably synchronized and represented in a chosen focal plane. For example, given two video sequences with each showing a different contestant individually racing the same down-hill course, the composite sequence can include elements from each of the given sequences to show the contestants as if racing simultaneously.

Additionally, WO 2007/006346 A1 discloses a method for analyzing the motion of an athlete by defining a number of unevenly distributed key positions for a certain sport. The method extracts still pictures corresponding to the key positions from the input video, and displays the extracted still pictures simultaneously on the screen. The extraction of still pictures can be triggered by a predefined template.

However, in the above existing systems, the motion of an athlete is analyzed by unfolding the video as a sequence of still pictures/frames, where pre-defined templates/rules can be used to extract still pictures corresponding to key positions. However, for viewers, it is still not possible to see how the athlete moves at each individual moment/frame. For instance, different athletes may execute the same key positions with different speeds and moving directions.

When comparing two videos, spatial and temporal alignment is considered in the existing systems. However, this is done by only aligning the existing images/frames in the videos. Given two different performances (from different subjects), because of different execution of the movement (e.g., different speeds or amplitude), spatial-temporal alignment based on the existing frames could be difficult, sometimes leading to inaccurate alignment.

U.S. Pat. No. 7,602,301 and U.S. Pat. No. 6,567,536 disclose solutions for motion analysis based on on-body sensors, but these require extra markers and sensors to be applied on the body.

### SUMMARY OF THE INVENTION

It is an object of the present invention to provide a solution for better movement analysis and comparison, while maintaining unobtrusive data-gathering through video.

This object is achieved by an apparatus as claimed in claim 1, by a method as claimed in claim 8, and by a computer program product as claimed in claim 9.

Accordingly, movements of any type of object in video sequences can be analyzed quantitatively and automatically by applying motion estimation techniques, without any users' manual drawing/clicking and also without using any on-body markers or sensors. The motion estimation results enable better movement analysis and comparison, particularly in sports, while maintaining unobtrusive data-gathering through video. With the calculated motion vectors, intermediate frames can be generated and inserted to enable better alignment. For example, when comparing the sprint of two athletes, intermediate frames can be inserted for faster running athletes. Another application is when comparing two videos captured with cameras of different frame rates. For example, in some cases, one recoding could be made by a high-speed camera. The other recoding made by a low frame rate needs to be enhanced with intermediate frames for better movement comparison.

According to a first aspect, a visualizer or visualizing stage may be provided for visualizing the movement of the at least one object.

According to a second aspect which can be combined with the first aspect, a video generator or video generating stage may be provided for generating a third video sequence containing the difference of movements of objects of the first and second video sequences processed by the proposed method or apparatus. Thus, based on the comparison of two video streams, it is also possible to generate a special information video for analysis, in which an annotation is made of the difference in motion between the two streams. One could for instance think of differences in knee-stretching between a swimmer and an ideal model (or a previous recording). Thus, in addition to providing two aligned video streams and then let this interpretation being done by the user (e.g. a coach or athlete), it would be possible to generate a third stream that is enhanced with or reduced to the difference in motion, so as to assist the user in seeing the difference.

According to a third aspect which can be combined with at least one of the first and second aspects, the visualizer or visualizing stage may be adapted to visualize the movement of the object by adding information about at least one of movement direction, movement magnitude and acceleration. In a specific exemplary implementation, the visualizer or visualizing stage may be adapted to add the information as a color coding.

According to a fourth aspect which can be combined with at least one of the above first to third aspects, the visualizer or visualizing stage may be adapted to detect predetermined objects of interest (e.g. body parts) in the at least one video sequence.

The above apparatus may be implemented as a hardware circuit integrated on a single chip or chip set, or wired on a circuit board. As an alternative, at least parts of the apparatus may be implemented as a computer program or software routine controlling a processor or computer device to carry out the steps of the above method, when the computer program is run on a computer controlling the apparatus.

It shall be understood that a preferred embodiment of the invention can also be any combination of the dependent claims with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows a schematic processing diagram of a movement comparison procedure or device according to a first embodiment,

FIG. 2 shows an example of a movement comparison; and

FIG. 3 shows a schematic processing diagram of a movement comparison procedure or device according to a second embodiment.

### DETAILED DESCRIPTION OF EMBODIMENTS

The invention will now be described based on embodiments where movements of the athletes or other objects are quantitatively analyzed in video sequences (e.g. sport videos). More specifically, video analysis is enhanced to extract motion data. Even in cases of different performances (by different subjects) with different execution of the movement (e.g. different speeds and/or moving directions), frame alignment can be achieved.

FIG. 1 shows a schematic diagram of a processing flow or chain according to a first embodiment where motion vectors at individual video frames are calculated using motion estimation or other techniques that can find the correspondences between video frames. Motion vectors calculated at individual video frames can be used to better compare movements. In step or stage 110 motion vectors are calculated for individual frames of at least two video sequences. The calculated motion vectors are then used in step or stage 120 to generate and insert intermediate frames. Regarding step or stage 120, the generation of an intermediate frame could be based on interleaving techniques from the video domain, where it is used e.g. for up-scaling from a first to a second frame rate (e.g. 50 to 200 Hz). This scale up may be performed using a non-integer factor. To compare movements in at least two video sequences (performed by different persons or the same person at different times), or between a video sequence and a reference sequence, the two sequences are aligned both spatially and temporally in step 130. Due to different execution of the movement (e.g., different speeds or amplitude), the spatial-temporal alignment based on the existing frames could be difficult. However, with the calculated motion vectors, intermediate frames can be generated and inserted to enable better alignment. For example, when comparing the sprint of two athletes, intermediate images can be composed for the faster running athlete when aligning the images for a distance covered.

Also, when comparing a field recording against a higher-speed-camera master video, the field recording may need to be enhanced to optimize comparison performance.

For example, in some cases, the recoding is made by high-speed cameras. The recoding made by low frame rate needs to be enhanced with intermediate frames for better movement comparison. Finally, in step 140, movement parameters of target objects or target portions are visualized for better comparison.

Thus, the motion vectors calculated in step or stage 110 can be used for comparing the movements. E.g., based on these motion vectors, intermediate frames can be inserted in step or stage 120 to enable better spatial and temporal alignment in step 130, leading to enhanced movement comparison.

The motion vectors at each frame may be derived by motion estimation techniques. There are different motion estimation algorithms in the literature. One of them is 3-D Recursive Search Block matching (3DRS). The calculated motion vectors are then used to enhance the video sequence. The motion can be visualized in step or stage 140 in different ways which can be selected according to the needs of the user or target audience (e.g. athletes, coaches, fans). As an example, color coding can be used to visualize the motion. When comparing movements in two videos, with one as baseline/reference, colors can be added to indicate different (or same) movements.

Furthermore, to more accurately measure the movements of the target object or object portion other cues can be taken into account. For example, for swimmers, skin color can be used to eliminate motion vectors in non-body areas. In some cases, people are interested to see movements of specific body parts (e.g., arm). Then, computer vision techniques can then be applied to automatically detect the body part of interest.

Further information can be derived from the estimated motion vectors, and used to enhance the video. For example, acceleration (i.e., the speed of movement speed) can be derived.

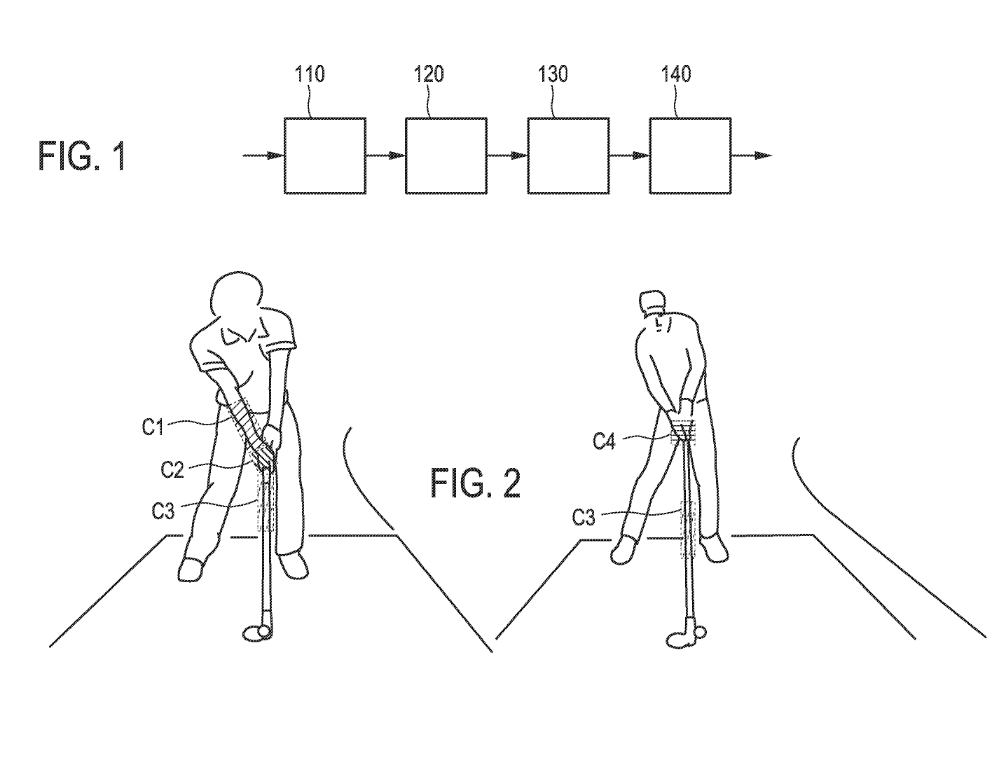

FIG. 2 shows examples of golf movements by two golf players. In these examples, a key frame is defined when the golf club touches the ball. Although both players execute this key position, they may have different motion. The motion estimation results at this key frame are visualized for both players using a color coding, wherein different colors are used to indicate different movement directions, while color intensity indicates the magnitude of the movements. In FIG. 2, the color coding is simplified by different hatching patterns C1 to C4. The proposed motion estimation shows the two players performing in a different way, i.e., different movement speeds and directions. As can be gathered from the hatching patterns C1 to C4 in FIG. 2, the movements of the right arm of the two players differ quite substantially.

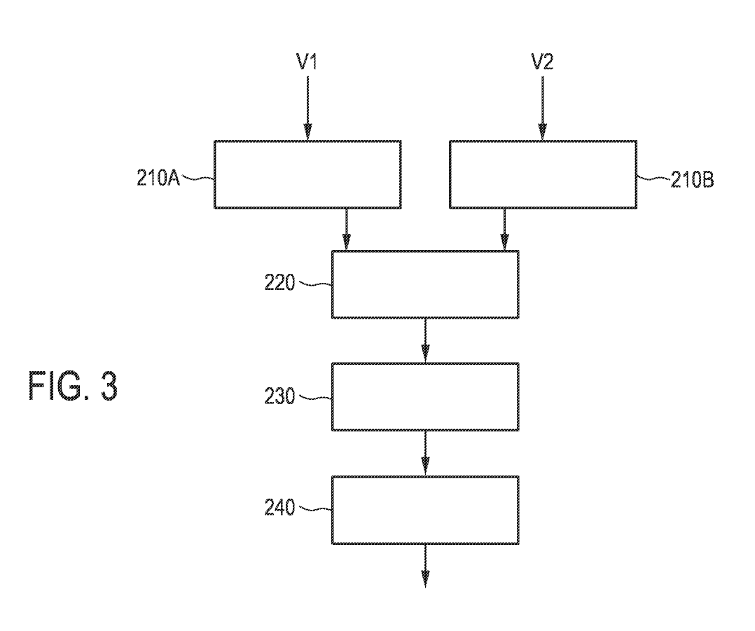

FIG. 3 shows a schematic diagram of a processing flow or chain according to a second embodiment where a video sequence containing a movement difference between two target objects of two input video sequences V1 and V2 is generated. In steps or stages 210A and 210B, motion vectors are calculated for individual frames of said input video sequences V1 and V2. In step or stage 220 intermediate frames of an intermediate frame composition are generated for and inserted into at least one of the input video sequences V1, V2 based on the calculated motion vectors. Then, in step or stage 230, the two video sequences V1, V2 of which at least one has been enhanced by the inserted intermediate frames are aligned spatially and temporally. In the second embodiment, based on the comparison of the two video sequences V1, V2, a special information video is generated in step or stage 240 for analysis, in which the difference in motion between the two video sequences V1, V2 is added or which have been reduced to this difference. As an example, such differences could be differences in knee-stretching between a swimmer and an ideal model (or a previous recording). So, in addition to providing two aligned video sequences and then let this interpretation being done by a user (e.g. coach or athlete), a third video sequence is generated that is enhanced with or reduced to the difference in motion, so as to assist the user in identifying and evaluating the difference.

To summarize, the present invention proposes to analyze movements of objects in video sequences (e.g. sport videos), by performing motion estimation to determine motion vectors at each frame. With the calculated motion vectors, the movements of the object(s) (e.g. athlete(s)) can be quantitatively measured. Based on this, movements in two videos can be compared at each individual frame of the video sequence. Different approaches (e.g., color coding) can be used to visualize and compare the movements. With motion estimation, intermediate frames can also be inserted to enable better movement comparison in two given videos.

The invention can be exploited as enhancements for (sports) video broadcasting. As a way for performance feedback, the invention can be used by coaches or athletes for training purposes. It can also be used in sport broadcasting for enhanced viewer experience. The invention can be implemented in display devices, such as televisions (TVs) or other displays, as an additional function of TV e.g. for watching sports. It can also be implemented in a TV studio for broadcasting. Another application is in gaming and gambling as described in WO 01/26760, for example, or surveillance and military, as inspired by U.S. Pat. No. 6,567,536, for example. As a way for performance feedback, it can also be used by coaches or athletes for training purposes. Another application is gaming or entertainment, where this invention enhances the analysis of differences with a golden-reference model or real person. An example could be a video-supported game, where a camera is used to record movements of a player, and the system then provides the feedback mentioned here.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

The steps or stages of FIGS. 1 and 3 can be performed by a single unit or by any other number of different units. The calculations, processing and/or control of the proposed movement analysis and/or comparison can be implemented as program code means of a computer program and/or as dedicated hardware.

A computer program may be stored/distributed on a suitable medium, such as an optical storage medium or a solid-state medium, supplied together with or as part of other hardware, but may also be distributed in other forms, such as via the Internet or other wired or wireless telecommunication systems.

Any reference signs in the claims should not be construed as limiting the scope.

The present invention proposes to analyze movements of objects in video sequences (e.g. sport videos), by performing motion estimation to determine motion vectors at each frame. With the calculated motion vectors, the movements of the object(s) (e.g. athlete(s)) can be quantitatively measured. Based on this, movements in two videos can be compared at each individual frame of the video sequence. Different approaches (e.g., color coding) can be used to visualize and compare the movements. With motion estimation, intermediate frames can also be inserted to enable better movement comparison in two given videos.

1. An apparatus for analyzing a movement of different objects or same objects at different times captured in at least two video sequences, said apparatus comprising:
a motion estimator for calculating motion vectors of said objects at individual frames of a first video sequence of said at least two video sequences;
a frame interpolator for generating and inserting intermediate frames into said first video sequence based on said calculated motion vectors to upscale a frame rate of said first video sequence; and
a frame aligner for performing spatial and temporal alignment of frames of said upscaled first video sequence with frames of a second video sequence of said at least two video sequences.

2. The apparatus according to claim 1, further comprising a visualizer for visualizing said movement of said at least one object.

3. The apparatus according to claim 1, further comprising a video generator for generating a third video sequence containing a difference of movements of objects of said first and second video sequences processed by said apparatus.

4. The apparatus according to claim 2, wherein said visualizer is adapted to visualize said movement of said object by adding information about at least one of movement direction, movement magnitude and acceleration.

5. The apparatus according to claim 4, wherein said visualizer is adapted to add said information as a color coding.

6. The apparatus according to claim 2, wherein said visualizer is adapted to detect predetermined objects of interest in said first and second video sequences.

7. A display device comprising an apparatus according to claim 1.

8. A gaming device comprising a display according to claim 7.

9. A method of analyzing a movement of different objects or same objects at different times captured in at least two video sequences, said method comprising:
calculating motion vectors of said objects at individual frames of a first video sequence of said at least two video sequences;
generating and inserting intermediate frames into said first video sequence based on said calculated motion vectors to upscale a frame rate of said first video sequence; and
performing spatial and temporal alignment of frames of said first video sequence with frames of a second video sequence of said at least two video sequences.

10. A computer program comprising code for producing the steps of method claim 9 when run on a computing device.
